(19) United States
(12) Patent Application Publication
(10) Pub. No.: US 2017/0076648 A1
(43) Pub. Date: Mar. 16, 2017

(54) GAMMA VOLTAGE GENERATING CIRCUIT, DRIVING UNIT, DISPLAY APPARATUS AND CHROMATICITY COORDINATE ADJUSTING METHOD

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Chuanyan LAN, Beijing (CN); Xiuzhu TANG, Beijing (CN); Fucheng YANG, Beijing (CN)

(73) Assignee: BOE TECHNOLOGY GROUP CO., LTD., Beijing (CN)

(21) Appl. No.: 14/914,841

(22) PCT Filed: Sep. 21, 2015
(86) PCT No.: PCT/CN2015/090101

§ 371 Date: Feb. 26, 2016

(30) Foreign Application Priority Data
Apr. 17, 2015 (CN) 201510184943.9

(51) Int. Cl. G09G 3/20

(52) U.S. Cl. CPC G09G 3/2003; G09G 3/2092; G09G 2320/0673; G09G 2320/0233

(57) ABSTRACT

There are provided a Gamma voltage generating circuit, a driving unit, a display apparatus and a chromaticity coordinate adjusting method. The Gamma voltage generating circuit includes: a voltage reducing unit configured to reduce an inputted source voltage to obtain an initial voltage of a Gamma voltage; a voltage dividing unit configured to divide the initial voltage of the Gamma voltage to generate respective scales of Gamma voltages; and a voltage increasing unit configured to produce an additional voltage signal, and the additional voltage signal produced by the voltage increasing unit is used to be superimposed on the initial voltage of the Gamma voltage. The Gamma voltage generating circuit is capable of adjusting chromaticity coordinate to make display effect of the display apparatus consistent, and would not reduce luminance of a white picture accordingly.

### TECHNICAL FIELD

The present disclosure relates to a Gamma voltage generating circuit, a driving unit, a display apparatus and a chromaticity coordinate adjusting method.

### BACKGROUND

A liquid crystal display has become a main product in the display field at present due to its advantages of zero radiation, low power consumption, small heat dissipation, small size, accurate image restoring, and sharp character display and so on.

The liquid crystal display is mainly constituted of a display panel, a back light module and a driver chip (driver IC). In a project of the same display product, a plurality of suppliers of back light modules may exist at the same time. Different manufacturers of back light modules or production of display panels have difference in aspects of process and technology or the like, which would cause inconsistency in a single base color such as red, green and blue (RGB) in a pure white picture. As a result, it makes that even if display panels of the same type are used, phenomenon that a display picture becomes reddish or yellowish would also occur if the display panels matches with back light modules of different manufactures.

In order to mediate deficiencies caused by differences among different suppliers, it needs to improve the back light module or the display panel. However, any change of the back light module or the display panel would be complicated, and spends much time. Therefore, a method of adjusting 255 gray scale voltage of RGB to be different via the driver IC is mostly adopted at present. That is, if a back light module of a manufacturer matches with the display panel, it requires a reddish white picture to make a final display effect consistent with a predetermined standard. In this way, it needs to weaken voltages of other two colors (green and blue) in the white picture, so that the red would be prominent relatively. Although doing in this way achieves the purpose of making a certain single color prominent and the entire display effect consistent during driving, it reduces luminance of the white picture at the same time (the white picture is synthesized by R255, G255 and B255, and the luminance of the white picture would be reduced if any one of them is reduced).

### SUMMARY

There are provided in embodiments of the present disclosure a Gamma voltage generating circuit, a driving unit, a display apparatus and a chromaticity coordinate adjusting method, which are capable of adjusting chromaticity coordinate to make display effect of the display apparatus consistent, and would not reduce luminance of a white picture accordingly, so that the problem of inconsistency in display effect of the display apparatus caused by differences in material and process of respective suppliers of the display panel and the back light module would be solved.

For example, the embodiments of the present disclosure can be realized by adopting following solutions:

A Gamma voltage generating circuit comprises a voltage reducing unit, a voltage dividing unit and a voltage increasing unit; the voltage reducing unit is configured to reduce an inputted source voltage to obtain an initial voltage of a Gamma voltage; the voltage dividing unit is configured to divide the initial voltage of the Gamma voltage to generate respective scales of Gamma voltages; the voltage increasing unit is configured to produce an additional voltage signal, the additional voltage signal produced by the voltage increasing unit is used to be superimposed on the initial voltage of the Gamma voltage.

According to one aspect of the present disclosure, there is provided a Gamma voltage generating circuit, comprising:

a voltage reducing unit configured to reduce an inputted source voltage to obtain an initial voltage of a Gamma voltage;

a voltage dividing unit configured to divide the initial voltage of the Gamma voltage to generate respective scales of Gamma voltages;

a voltage increasing unit configured to produce an additional voltage signal, the additional voltage signal produced being used to be superimposed on the initial voltage of the Gamma voltage.

Optionally, the source voltage of the voltage reducing unit includes a positive source voltage AVDD and a negative source voltage AVEE. The initial voltage of the Gamma voltage obtained by reducing voltage through the voltage reducing unit includes: a highest voltage VGMN of a negative gray scale voltage and a highest voltage VGMP of a positive gray scale voltage. The additional voltage signal produced by the voltage increasing unit includes a positive additional voltage signal and a negative additional voltage signal. The positive additional voltage signal is used to be superimposed on the highest voltage VGMP of the positive gray scale voltage, and the negative additional voltage signal is used to be superimposed on the highest voltage VGMN of the negative gray scale voltage.

Optionally, the voltage increasing unit obtains the additional voltage signal by dividing the source voltage, or obtains the additional voltage signal by driving other circuits nearby the Gamma voltage generating circuit in a time division multiplexing mode.

There is further provided in the present disclosure a driving unit, comprising any one of the Gamma voltage generating circuit described above.

There is further provided in the present disclosure a display apparatus, comprising the driving unit described above, or comprising any one of Gamma voltage generating circuit described above.

The display apparatus can further comprise: an enhancement function initiating unit configured to receive a white picture single color enhancement instruction, and generate a control signal for starting the voltage increasing unit according to the white picture single color enhancement instruction.

According to another aspect, there is further provided in the present disclosure a chromaticity coordinate adjusting method, comprising:

when a white picture single color requires to be enhanced, superimposing an additional voltage on a highest scale of Gamma voltage of a single color driving voltage that requires to be enhanced.

Optionally, superimposing an additional voltage on a highest scale of Gamma voltage of a single color driving voltage that requires to be enhanced is implemented particularly by the following mode: when the white picture single color requires to be enhanced, superimposing an additional voltage on an initial voltage inputted to a voltage dividing voltage, wherein the voltage dividing unit is arranged in a Gamma voltage generating circuit and configured to divide the initial voltage of the Gamma voltage to generate respective scales of Gamma voltages.

The embodiments of the present disclosure provide a Gamma voltage generating circuit, a driving unit, a display apparatus and a chromaticity coordinate adjusting method. An additional voltage signal is superimposed on the initial voltage of the Gamma voltage, such that the respective scales of Gamma voltages generated are enhanced entirely, so as to achieve the effect of enhancing luminance of a single color. The solutions of the present disclosure are capable of solving the problem of inconsistency in chromaticity coordinate of the display apparatus caused by differences in material and process of respective suppliers of the display panel and the back light module, and luminance of the white picture would not be reduced accordingly.

### BRIEF DESCRIPTION OF THE DRAWINGS

FIG. 1 is a schematic diagram of an architecture of a Gamma voltage generating circuit;

FIG. 2 is a schematic diagram of a driving voltage of a white picture pixel;

FIG. 3 is a schematic diagram of an architecture of a Gamma voltage generating circuit provided in an embodiment of the present disclosure;

FIG. 4 is a schematic diagram of a driving voltage of a white picture pixel provided in an embodiment of the present disclosure;

FIG. 5 is a schematic diagram of a specific implementation of a voltage increasing unit provided in an embodiment of the present disclosure.

### DETAILED DESCRIPTION

Technical solutions in embodiments of the present disclosure will be described below clearly and completely by combing with the drawings. Obviously, the embodiments described are just a part of embodiments of the present disclosure, but not all of the embodiments. Based on the embodiments in the present disclosure, all of other embodiments obtained by those ordinary skilled in the art without paying any inventive labor belong to the scope sought for protection in the present disclosure.

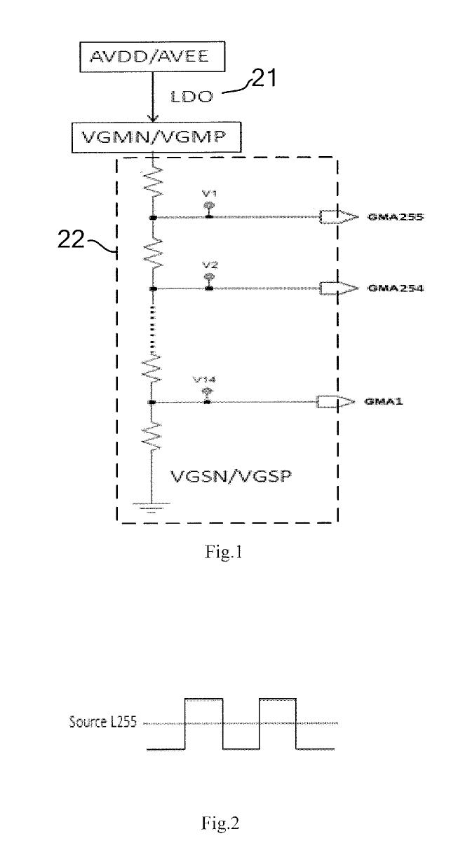

FIG. 1 shows a schematic diagram of architecture of a Gamma voltage generating circuit.

As shown in FIG. 1, the Gamma voltage generating circuit comprises: a low dropout regulator (LDO) 21 and a voltage dividing unit 22. A source voltage inputted to the LDO 21 includes a positive source voltage AVDD and a negative source voltage AVEE. An initial voltage of a Gamma voltage obtained by reducing voltage through the LDO 21 includes a highest voltage VGMN of a negative gray scale voltage and a highest voltage VGMP of a positive gray scale voltage. Then, the voltage dividing unit 22 divides the initial voltage of the Gamma voltage to generate respective scales of Gamma voltages (GMA1-GMA255). Herein, the low dropout regulator (LDO) is a linear regulator, which reduce excess voltage from applied input voltage and produces adjusted output voltage by using transistors or field effect transistors operated in a linear region thereof.

According to the architecture of the Gamma voltage generating circuit, the initial voltage of the Gamma voltage (VGMN/VGMP in FIG. 1 represents the initial voltage of the Gamma voltage) is obtained by reducing the voltage of the previous stage of the circuit, i.e., the source voltage (AVDD/AVEE in FIG. 1 represents the source voltage).

FIG. 2 shows a schematic diagram of a driving voltage of a white picture pixel. As shown in FIG. 2, each pixel drives the voltage (i.e., Source L255 in FIG. 2) to reverse once each frame during the white picture.

In order to not only enhance the voltage corresponding to a certain single color relative to an original voltage and achieve the desired effect of enhancing the single color, but also not cause the luminance reduction, the embodiment of the present disclosure designs a voltage branch for the source voltage. Partial voltage is superimposed additionally on the basis of the original voltage by synchronous the time-division multiplexing, thereby achieving the effect of enhancing the voltage corresponding to a certain color under the gray scale of 255. In this way, the differences in the material and process of the respective suppliers can be synthesized by only using software (such as, a code debugging method).

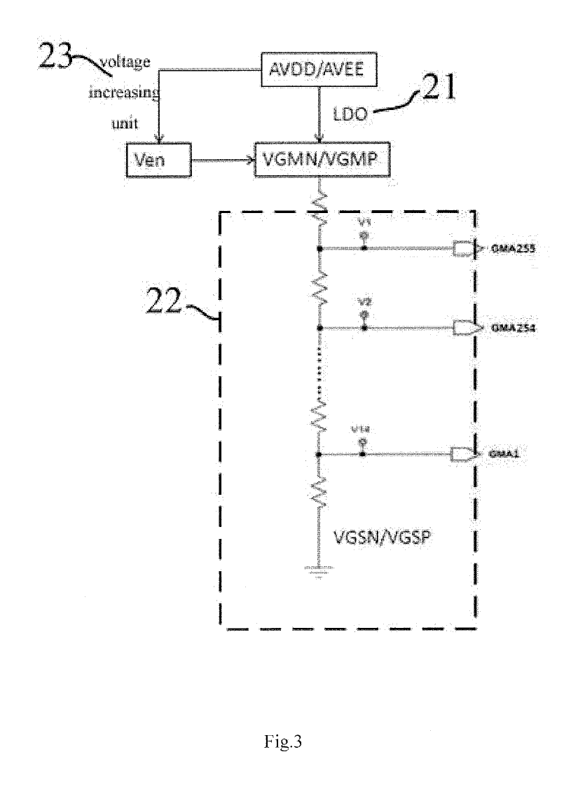

FIG. 3 shows a schematic diagram of architecture of a Gamma voltage generating circuit provided in an embodiment of the present disclosure. As shown in FIG. 3, the Gamma voltage generating circuit comprises: a voltage reducing unit 21 (for example, LDO in FIG. 3) and a voltage dividing unit 22. The voltage reducing unit 21 is configured to reduce the inputted source voltage to obtain the initial voltage of the Gamma voltage. The voltage dividing unit 22 is configured to divide the initial voltage of the Gamma voltage to generate respective scales of Gamma voltages (GMA1-GMA255). The Gamma voltage generating circuit can further comprise: a voltage increasing unit 23 configured to produce an additional voltage signal Ven, and the additional voltage signal Ven produced by the voltage increasing 23 is used to be superimposed on the initial voltage of the Gamma voltage.

In order to achieve the effect of enhancing a single base color (in general, it is one of three base colors, i.e., red, green, and blue), it needs to superimpose the additional voltage signal Ven produced by the voltage increasing unit 23 on the initial voltage of the Gamma voltage corresponding to the base color.

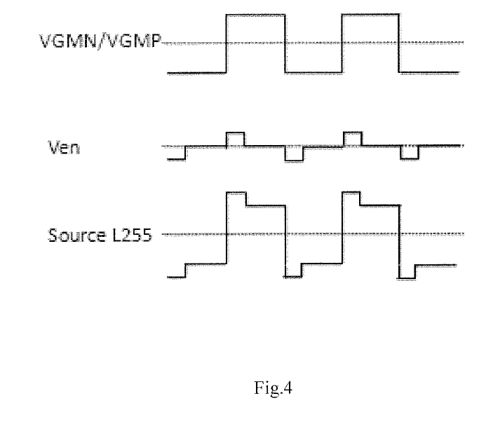

FIG. 4 shows a schematic diagram of a driving voltage of a white picture pixel provided in an embodiment of the present disclosure. As shown in FIG. 4, the initial voltage corresponding to the certain base color is enhanced on the basis of the original voltage, while the initial voltages corresponding to other base colors are kept unchanged. In this way, not only the respective scales of Gamma voltages corresponding to the certain base color are enhanced entirely to achieve the effect of brightening the single color, but also it is not necessary to adjust the voltages corresponding to other base colors, and thus the luminance of the white picture would not be reduced. The solution of the present disclosure is capable of solving the problem of inconsistency in chromaticity coordinate of the display apparatus caused by the differences in material and process of respective suppliers of the display panel and the back light module, and luminance of the white picture would not be reduced accordingly.

Optionally, the source voltage of the voltage reducing unit 21 includes a positive source voltage AVDD and a negative source voltage AVEE. The initial voltage of the Gamma voltage obtained by reducing the voltage through the voltage reducing unit 21 includes: a highest voltage VGMN of a negative gray scale voltage and a highest voltage VGMP of a positive gray scale voltage. As shown in FIG. 4, the additional voltage signal Ven produced by the voltage increasing unit 23 includes a positive additional voltage signal used to be superimposed on the highest voltage VGMP of the positive gray scale voltage, and further includes a negative additional voltage signal used to be superimposed on the highest voltage VGMN of the negative gray scale voltage.

It should be noted that FIGS. 1 and 3 only schematically show the architecture diagrams of the Gamma voltage generating circuit, but not specific circuit diagrams. Any skilled in the art who is familiar with the present technical field can make various designs to the specific circuit, within the technical scope disclosed in the present disclosure, based on the inventive concept provided in the present disclosure that the additional voltage is superimposed on the initial voltage of the Gamma voltage to enhance the respective scales of Gamma voltages entirely. These designs shall be covered within the protection scope of the present disclosure.

In addition, the embodiment of the present disclosure does not limit the specific implementation of the voltage increasing unit 23, which may be any implementation well known for those skilled in the art. For example, the voltage increasing unit 23 can obtain the additional voltage signal Ven by dividing the source voltage, or can obtain the additional voltage signal Ven by driving other circuits nearby the Gamma voltage generating circuit in a time division multiplexing mode. This implementation utilizes directly the nearby circuit to realize the function of the voltage increasing unit 23, without bringing in any new module, so that the circuit can be simplified.

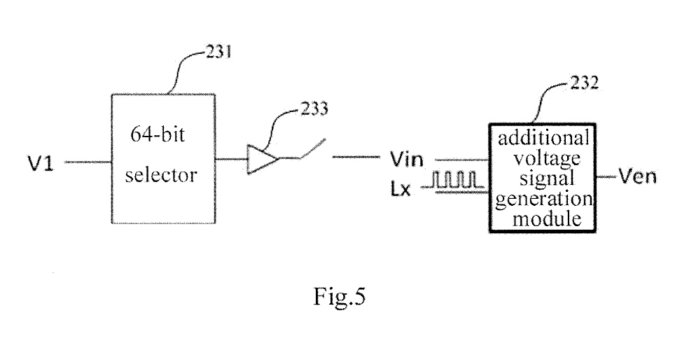

FIG. 5 shows an optional implementation of a voltage increasing unit provided in an embodiment of the present disclosure. As shown in FIG. 5, V1 in FIG. 5, i.e., the input voltage of the voltage increasing unit 23 (it may be a source voltage or other bypass voltages), is selected by a 64-bit selector 231, and its output voltage is set as a voltage output having a smaller voltage value (i.e., an output voltage Vin). This output voltage Vin is inputted to an additional signal generation module 232 through an diode 233. Another input terminal (or control terminal) of the additional voltage signal generation module 232 is inputted a control signal LX. The additional voltage signal generation module 232 has such a function: under the control of the control signal LX, selecting whether to output the output voltage Vin of the 64-bit selector (in a specific implementation, it may be that a level of the output voltage Vin of the 64-bit selector is outputted directly, or that the level of the output voltage of the 64-bit selector is adjusted and then outputted). For example, optionally, when the control signal LX is at a high level, a level of the additional voltage signal Ven outputted by the additional voltage signal generation module 232 is Vin; when the control signal LX is at a low level, the level of the additional voltage signal Ven outputted by additional voltage signal generation module 232 is 0. That is, Vin is used to control an amplitude of the outputted additional voltage signal Ven, and the control signal LX is used to control a frequency of the outputted additional voltage signal Ven. The additional voltage signal generation module 232 may be an AND gate logic circuit for example, but not limited thereto.

To sum up, the solution of the embodiment of the present disclosure is improved in the aspect of hardware. When the single color enhancement function is initiated, the additional voltage signal is superimposed on the initial voltage of the Gamma voltage. In this way, it enables to not only make the respective scales of Gamma voltages corresponding to the certain base color enhanced entirely, but also, for the white picture, the additional voltage signal Ven and the highest voltage VGMN of the negative gray scale voltage/the highest voltage VGMP of the positive gray scale voltage are taken jointly as the driving voltage of the whiter picture, thereby achieving the effect of adjusting color shift of the white picture but not reducing the entire luminance of the white picture.

With respect to certain color shift problems to be solved, there have already existed some Color Enhancement technologies at present. However, the existing color enhancement technologies can generally only apply an algorithm to increase the luminance of middle gray scales. If greenish is desired, G27 would be processed as G30, but re-enhancement process cannot be performed on G255. Or, if it requires to enhance a certain color whose gray scale voltage is 255, it can only be realized by reducing the luminance of 255-scale of other colors, but as a result, the entire luminance of the white picture would be weakened. However, by adopting the solution of the embodiment of the present disclosure, since it is improved directly in the aspect of hardware, when the single color enhancement function is initiated, the additional voltage signal is superimposed on the initial voltage of the Gamma voltage, which not only can enhance the respective scales of Gamma voltages corresponding to the certain base color, but also for the white picture, as shown in FIG. 4, the additional voltage signal Ven and the highest voltage VGMN of the negative gray scale voltage/the highest voltage VGMP of the positive gray scale voltage are taken jointly as the driving voltage (Source L255) of the white picture, so as to achieve the effect of adjusting the color shift of the white picture without reducing the entire luminance of the white picture.

There is further provided in an embodiment of the present disclosure a driving unit, comprising any one of the Gamma voltage generating circuit described in the above embodiments. The driving unit can realize chromaticity coordinate adjustment, so that the problem of inconsistency in chromaticity coordinate of the display apparatus caused by differences in material and process of respective suppliers of the display panel and the back light module is solved, and luminance of the white picture would not be reduced accordingly. The driving unit can provide a driving signal for any product or components having a display function, such as a liquid crystal panel, an electronic paper, an OLED panel, a mobile phone, a tablet computer, a television set, a display, a notebook computer, a digital framework, and a navigator, etc.

There is further provided in an embodiment of the present disclosure a display apparatus, which is provided with the driving unit described above, or any one of the Gamma voltage generating circuit described in the above embodiments. The display apparatus is capable of solving the problem of inconsistency in chromaticity coordinate of the display apparatus caused by the differences in material and process of the respective suppliers of the display panel and the back light module, and luminance of the white picture would not be reduced accordingly. The display apparatus can be any product or means having a display function, such as a liquid crystal panel, an electronic paper, an OLED panel, a mobile phone, a tablet computer, a television set, a display, a notebook computer, a digital framework, and a navigator, etc.

Further, the display apparatus can further comprise: an enhancement function initiating unit configured to receive a white picture single color enhancement instruction and initiate a control unit of the voltage increasing unit according to the white picture single color enhancement instruction. Physical or virtual keys can be formed outside the display apparatus to receive the white picture single color enhancement instruction. Inside the display apparatus (generally on a chip setting the driving unit), the enhancement function initiating unit produces a control signal for initiating the voltage increasing unit according to the white picture single color enhancement instruction. The circuit where the voltage increasing unit is located is provided with a controllable switch which can receive the control signal for initiating the voltage increasing unit so as to turn on the circuit where the voltage increasing unit is located, and then the voltage increasing unit starts to operate (or the controllable switch is not disposed, and the voltage increasing unit itself receives the control signal for initiating the voltage increasing unit to operate), and the additional voltage signal produced by the voltage increasing unit is superimposed on the initial voltage of the Gamma voltage, thereby realizing the effect of enhancing a single color.

It should be noted that the white picture single color enhancement or the white picture single color enhancement instruction mentioned in the respective embodiments of the present disclosure is used to emphasize that the solution of the present embodiment can not only realize enhancing a certain single color, but also make the single color enhanced absolutely during the white picture (corresponding to the highest scale of Gamma voltage of the respective single colors), but not the mode of enhancing the single color relatively by reducing the voltages of base colors other than the single color.

According to another aspect, there is further provided in an embodiment of the present disclosure a chromaticity coordinate adjusting method, comprising, when a white picture single color needs to be enhanced, superimposing an additional voltage on a highest scale of Gamma voltage of a driving voltage of the single color that requires to be enhanced.

Each pixel is composed of three sub-pixels R, G, B. In general, the current driver chip supports that R/G/B gray scale voltages are controlled uniformly, but there are also some driver chips supporting that R/G/B gray scale voltages are controlled separately. However, in either case, only if the highest Gamma voltage (i.e., GMA255) of the single color driving voltage that requires to be enhanced can be raised on the original basis, a certain single color can be brightened in the case of not reducing the white picture luminance, so as to realize the purpose of adjusting the white picture chromaticity coordinate.

Optionally, the above process of superimposing an additional voltage on a highest scale of Gamma voltage of a single color driving voltage that requires to be enhanced can be implemented by means of the following mode: when the white picture single color requires to be enhanced, superimposing an additional voltage on an initial voltage inputted to a voltage dividing voltage, the voltage dividing unit is arranged in a Gamma voltage generating circuit and configured to divide the initial voltage of the Gamma voltage to generate respective scales of Gamma voltages.

The chromaticity coordinate adjusting method provided in the embodiment of the present disclosure makes the initial voltage corresponding to the base color enhanced on the basis of the original voltage, while initial voltages corresponding to other base colors are unchanged. In this way, not only the color shift of the white picture can be adjusted without reducing the luminance of the white picture, but also the respective scales of Gamma voltages corresponding to a certain base color can be enhanced entirely, so that the effect of brightening a certain single color entirely is achieved, and thus the problem of inconsistency in chromaticity coordinate of the display apparatus caused by differences in material and process of respective suppliers of the display panel and the back light module is solved.

The respective embodiments in the specification are described in a progressive manner. The same or similar parts among the respective embodiments can refer to each other. What described mainly in each embodiment is the difference than other embodiments. In particular, for the method embodiment, since it is basically similar to the apparatus embodiment, and thus it is described briefly, please refer to the parts of the description of the apparatus embodiment for the related content.

Those ordinary skilled in the art would understand that all or part of flows that realize the methods in the above embodiments can be completed by a computer program instruction related hardware. The program can be stored in a computer readable storage medium. When this program is executed, flows of embodiments of respective methods described above can be comprised. Herein, the storage medium can be a magnetic disk, an optical disk, a read-only memory (ROM) or a random access memory (RAM) and so on.

The above descriptions are just specific implementations of the present disclosure, but the protection scope of the present disclosure is not limited thereto. Any alternation or replacement that can be easily conceived by those skilled in the art who are familiar with the technical field within the technical scope disclosed in the present disclosure shall fall into the protection scope of the present disclosure. Therefore, the protection scope of the present disclosure shall be subjected to the protection scope of the Claims.

The present application claims the priority of a Chinese patent application No. 201510184943.9 filed on Apr. 17, 2015. Herein, the content disclosed by the Chinese patent application is incorporated in full by reference as a part of the present disclosure.

1. A Gamma voltage generating circuit, comprising:
a voltage reducing unit configured to reduce inputted source voltage to obtain initial voltage of the Gamma voltage;
a voltage dividing unit configured to divide the initial voltage of the Gamma voltage to generate respective scales of Gamma voltages; and
a voltage increasing unit configured to produce an additional voltage signal, and the produced additional voltage signal is used to be superimposed on the initial voltage of the Gamma voltage.

2. The Gamma voltage generating circuit according to claim 1, wherein the source voltage of the voltage reducing unit includes a positive source voltage AVDD and a negative source voltage AVEE, and the initial voltage of the Gamma voltage obtained by reducing voltage through the voltage reducing unit includes: a highest voltage VGMN of a negative gray scale voltage and a highest voltage VGMP of a positive gray scale voltage.

3. The Gamma voltage generating circuit according to claim 2, wherein the additional voltage signal produced by the voltage increasing unit includes a positive additional voltage signal and a negative additional voltage signal, the positive additional voltage signal is used to be superimposed on the highest voltage VGMP of the positive gray scale voltage, and the negative additional voltage signal is used to be superimposed on the highest voltage VGMN of the negative gray scale voltage.

4. The Gamma voltage generating circuit according to claim 1, wherein the voltage increasing unit obtains the additional voltage signal by dividing the source voltage.

5. The Gamma voltage generating circuit according to claim 1, wherein the additional voltage signal is obtained by driving other circuits nearby the Gamma voltage generating circuit in a time division multiplexing mode.

6. A driving unit, comprising the Gamma voltage generating circuit according claim 1.

7. A display apparatus, comprising the driving unit according to claim 6.

8. The display apparatus according to claim 7, further comprising:
an enhancement function starting unit configured to receive a white picture single color enhancement instruction, and generate a control signal for starting the voltage increasing unit according to the white picture single color enhancement instruction.

9. A chromaticity coordinate adjusting method, comprising:
when a white picture single color requires to be enhanced, superimposing an additional voltage on a highest scale of Gamma voltage of a single color driving voltage that requires to be enhanced.

10. The chromaticity coordinate adjusting method according to claim 9, wherein superimposing an additional voltage on a highest scale of Gamma voltage of a single color driving voltage that requires to be enhanced comprises:
when the white picture single color requires to be enhanced, superimposing an additional voltage on an initial voltage inputted to a voltage dividing voltage, wherein the voltage dividing unit is arranged in a Gamma voltage generating circuit and configured to divide the initial voltage of the Gamma voltage to generate respective scales of Gamma voltages.

11. The Gamma voltage generating circuit according to claim 2, wherein the voltage increasing unit obtains the additional voltage signal by dividing the source voltage.

12. The Gamma voltage generating circuit according to claim 3, wherein the voltage increasing unit obtains the additional voltage signal by dividing the source voltage.

13. The Gamma voltage generating circuit according to claim 2, wherein the additional voltage signal is obtained by driving other circuits nearby the Gamma voltage generating circuit in a time division multiplexing mode.

14. The Gamma voltage generating circuit according to claim 3, wherein the additional voltage signal is obtained by driving other circuits nearby the Gamma voltage generating circuit in a time division multiplexing mode.

15. The driving unit according to claim 6, wherein the source voltage of the voltage reducing unit includes a positive source voltage AVDD and a negative source voltage AVE, and the initial voltage of the Gamma voltage obtained by reducing voltage through the voltage reducing unit includes: a highest voltage VGMN of a negative gray scale voltage and a highest voltage VGMP of a positive gray scale voltage.

16. The driving unit according to claim 15, wherein the additional voltage signal produced by the voltage increasing unit includes a positive additional voltage signal and a negative additional voltage signal, the positive additional voltage signal is used to be superimposed on the highest voltage VGMP of the positive gray scale voltage, and the negative additional voltage signal is used to be superimposed on the highest voltage VGMN of the negative gray scale voltage.

17. The driving unit according to claim 6, wherein the voltage increasing unit obtains the additional voltage signal by dividing the source voltage.

18. The driving unit according to claim 6, wherein the additional voltage signal is obtained by driving other circuits nearby the Gamma voltage generating circuit in a time division multiplexing mode.

19. The display apparatus according to claim 7, wherein the source voltage of the voltage reducing unit includes a positive source voltage AVDD and a negative source voltage AVEE, and the initial voltage of the Gamma voltage obtained by reducing voltage through the voltage reducing unit includes: a highest voltage VGMN of a negative gray scale voltage and a highest voltage VGMP of a positive gray scale voltage.

20. The display apparatus according to claim 19, wherein the additional voltage signal produced by the voltage increasing unit includes a positive additional voltage signal and a negative additional voltage signal, the positive additional voltage signal is used to be superimposed on the highest voltage VGMP of the positive gray scale voltage, and the negative additional voltage signal is used to be superimposed on the highest voltage VGMN of the negative gray scale voltage.
